(19) United States
(12) Patent Application Publication
(10) Pub. No.: US 2005/0223019 A1
(43) Pub. Date: Oct. 6, 2005

(54) Block-level sampling in statistics estimation

(75) Inventors: Gautam Das, Redmond, WA (US); Surajit Chaudhuri, Redmond, WA (US); Utkarsh H. Srivastava, Stanford, CA (US)

Correspondence Address: WATTS, HOFFMANN CO., L.P.A., Ste. 1750, 1100 Superior Ave., Cleveland, OH, 44114, US

(73) Assignee: Microsoft Corporation

(21) Appl. No.: 10/814,382

(22) Filed: Mar. 31, 2004

(51) Int. Cl. G06F 17/00

(52) U.S. Cl. 707/102

(57) ABSTRACT

System and apparatus for using block-level sampling for histograms construction as well as distinct-value estimations. For histogram construction, the system implements a two-phase adaptive method in which the sample size required to reach a desired accuracy is decided based on a first phase sample. This method is significantly faster than previous iterative block-level sampling methods proposed for the same problem. For distinct-value estimation, it is shown that existing estimators designed for uniform-random samples may perform very poorly with block-level samples. An exemplary system computes an appropriate subset of a block-level sample that is suitable for use with most existing estimators.

### FIELD OF THE INVENTION

The invention concerns database sampling for efficiently providing statistics regarding the data contained within the database.

### BACKGROUND ART

Database statistics are useful tools for use in efficiently building query execution plans based on an query workload of one or more queries. Obtaining database statistics by a full scan of large tables can be expensive. Building approximate statistics over a random sample of the data in the database is a known alternative. Constructing statistics such as histograms and distinct value estimates through sampling has been implemented using uniform random sampling of the database.

Uniform random sampling is too expensive unless the layout of the data in the database provides efficient random access to tuples or data records. Consider how uniform-random sampling is implemented. Suppose that there are 50 tuples per block of data and a 2% uniform-random sample is desired. The expected number of tuples that will be chosen from each block is 1. This means that the uniform-random sample will touch almost every block of the table. Reading a single tuple off the disk is no faster than reading the entire block on which it resides. There is usually a large difference between the speed of random access and sequential access on disk. Thus, in the case of 2% uniform-random sampling, accessing and building the sample will be no faster than doing a full scan of the table and the impracticalities of a full scan is what lead to the sampling process in the first place.

Uniform-random sampling is impractical except for very small (and hence uninteresting) sample sizes. Therefore, most commercial relational database systems provide the ability to do block-level sampling, in which to sample a fraction of q tuples of a table, a fraction q of the disk-blocks of the table are chosen uniformly at random, and all the tuples in these blocks are returned in the sample. Thus, in contrast to uniform-random sampling, block-level sampling requires significantly fewer block accesses (blocks are typically quite large, e.g., 8K bytes of data).

A problem with block-level sampling is that the sample is often no longer a uniform random sample and therefore misrepresents the data in the database. The accuracy of statistics built over a block-level sample depends on the layout of the data on disk, i.e., the way tuples are grouped into blocks. In one extreme, a block-level sample may be just as good as a uniform random sample, for example, when the layout is random, i.e., if there is no statistical dependence between the value of a tuple and the block in which it resides. However, in other cases, the values in a block may be fully correlated (e.g., if the table is clustered on the column on which the histogram is being built). In such cases, the statistics constructed from a block-level sample will be quite inaccurate when compared to those constructed from a uniform-random sample of the same size.

Given the high cost of uniform-random sampling, most prior art publications relating to statistics estimation through uniform random sampling can be viewed as being of theoretical significance. There is a need for robust and efficient extensions of those techniques that work with block-level samples. Surprisingly, despite the widespread use of block-level sampling in relational database products, there has been limited progress in database research in analyzing the impact of block-level sampling on statistics estimation. An example of prior art in this field is S. Chaudhuri, R. Motwani, and V. Narasayya. “Random sampling for histogram construction: How much is enough?” In Proc. of the 1998 ACM SIGMOD Intl. Conf. on Management of Data, pages 436-447, 1998. However, this prior art publication only addresses the problem of histogram construction from block-level samples.

Random sampling has been used as a technique for solving database problems. In statistics literature, the concept of cluster sampling is similar to block-level sampling. Other work addresses the problem of estimating query-result sizes through sampling. The idea of using cluster sampling to improve the utilization of the sampled data, was first proposed for this problem by Hou et. al. (W. Hou, G. Ozsoyoglu, and B. Taneja. Statistical estimators for relational algebra expressions. In Proc. of the 1988 ACM Symp. on Principles of Data base Systems, pages 276-287, March 1988.) However, Hou et al focus on developing consistent and unbiased estimators for COUNT queries, and the approach is not error driven. For distinct-value estimation with block-level samples, they simply use the Goodman's estimator (summarized below) directly on the block-level sample, recognizing that such an approach can lead to a significant bias.

The use of two-phase, or double sampling was first proposed by Hou et. al. (Error—Constrained COUNT Query Evaluation in Relational Databases. In Proc. of the 1991 ACM SIGMOD Intl. Conf. on Management of Data, pages 278-287, 1991), also in the context of COUNT query evaluation. However, their work considers uniform-random samples instead of block-level samples, and does not directly apply to histogram construction.

The use of random sampling for histogram construction was first proposed by Piatetsky-Shapiro et. al. “Accurate estimation of the number of tuples satisfying a ocndition.” In Proc of the 1984 ACM SIGMOD Intl. Conf. On Management of Data, pages 1-11, 1990. In this context, the problem of deciding how much to sample for a desired error, has been addressed. However, these derivations assume uniform random sampling. Only Chaudhuri et. al. (above and see also U.S. Pat. No. 6,278,989, issued Aug. 21, 2001) consider the problem of histogram construction through block-level sampling. They propose an iterative cross-validation based approach to arrive at the correct sample size for the desired error. However, in contrast to our two-phase approach, their approach often goes through a large number of iterations to arrive at the correct sample size, consequently incurring much higher overhead. Also, their approach frequently samples more than required for the desired error.

The problem of distinct value-estimation through uniform random sampling has received considerable attention. The Goodman's estimator (On the estimation of the number of classes in a population. Annals of Mathematical Statistics, 20: 572-579, 1949) is a unique unbiased distinct-value estimator for uniform random samples. However, it is unusable in practice due to its extremely high variance. The hardness of distinct-value estimation has been established by Charikar et. al. (Towards estimation error guarantees for distinct values. In Proc. Of the ACM Symp. on Principles of Database Systems, 2000) Most estimators that work well in practice do not give any analytical error guarantees. For the large sampling fractions that distinct-value estimators typically require, uniform-random sampling is impractical. Haas et. al. note that their estimators are useful only when the relation is laid out randomly on disk (so that a block-level random sample is as good as a uniform-random sample). However, distinct value estimation through block-level sampling has not been addressed.

The number of distinct-values is a popular statistic commonly maintained by database systems. Distinct-value estimates often appear as part of histograms, because in addition to tuple counts in buckets, histograms also maintain a count of the number of distinct values in each bucket. This gives a density measure for each bucket, which is defined as the average number of duplicates per distinct value. The bucket density is returned as the estimated cardinality of any query with a selection predicate of the form X=a, where a is any value in the range of the bucket, and X is the attribute over which the histogram has been built. Thus, any implementation of histogram construction through sampling should also solve the problem of estimating the number of distinct values in each bucket.

### SUMMARY OF THE INVENTION

A disclosed system and method effectively builds statistical estimators with block-level sampling in an efficiently way that is robust in the presence of correlations that may be present in the sample. Specifically, the disclosed exemplary embodiments provide an efficient way to obtain block-level samples for histogram construction as well as distinct-value estimation.

For histogram construction, the system determines a required sample size to construct a histogram with a desired accuracy. If the database table layout is fairly random then a small sample will suffice, whereas if the layout is highly correlated, a much larger sample is needed.

Two phase sampling is used to more efficiently construct a histogram. In a first phase, the process uses an initial block-level sample to determine how much more additional sampling is needed. This is done using cross-validation techniques. The first phase is optimized so that the cross validation can utilize a standard sort-based algorithm for building histograms. In a second phase, the process uses block-level sampling to gather the remaining sample, and then builds the histogram.

Distinct-value estimation is different from histogram construction. A procedure is described for selecting an appropriate data subset that results in distinct-value estimates that are almost as accurate as estimates obtained from uniform-random samples of similar size.

Exemplary embodiments are described in more detail in conjunction with the accompanying drawings.

### BRIEF DESCRIPTION OF THE DRAWINGS.

FIG. 1 is a flowchart of an exemplary process for building statistics based on sampling of a database;

FIG. 2 is an organization showing cross validation of sample data drawn from a database;

FIG. 3 is a plot of error versus sample size used in accordance with an exemplary system;

FIG. 4 is a flowchart of an exemplary process for building a distinct value estimator based on block level sampling of a database;

FIG. 5 is a block diagram of a computer system for use in practicing an exemplary embodiment of the invention; and

FIGS. 6 and 6A are block diagrams of a client-server based implementation of an exemplary system.

### EXEMPLARY EMBODIMENT FOR PRACTICING THE INVENTION

Many query-optimization methods rely on the availability of frequency statistics on database table columns or attributes. In a database table having 10 million records organized into pages, with an 8K byte block or page size, the 10 million records are stored on 100,000 pages or blocks of a storage system. These blocks of records can be accessed by block number using a database management system such as Microsoft SQL Server®.

Histograms have traditionally been a popular organization scheme for storing these frequency statistics compactly, and yet with reasonable accuracy. Any type of histogram can be viewed as partitioning the attribute domain into disjoint buckets and storing the counts of the number of tuples belonging to each bucket. Scanning the 10 million records of a representative table is not efficient and instead, the exemplary system samples blocks of data in an efficient manner to represent the database in an accurate enough manner to provide good statistics in the form of histograms that are constructed over the sampling.

The histogram counts are often augmented with density information, i.e., the average number of duplicates for each distinct value. To estimate density, a knowledge of the number of distinct values in the relevant column is required. Bucket counts help in cardinality estimation of range queries while density information helps for equality queries.

Consider the table of histogram buckets for a histogram provided below.

Histogram

| Bucket | Lower bound | Quantity | Distinct Values |
|---|---|---|---|
| B1 | 100 | 50 | 15 |
| B2 | 200 | 80 | 25 |
| B3 | 300 | 75 | 45 |
| . | . | . | . |
| . | . | . | . |
| . | . | . | . |
| B9 | 900 | 70 | 25 |

The table has five buckets and the boundaries for the buckets are spaced apart in equal increments by a range. The “Quantity” parameter documents the number of values falling within the range. Thus for example, the bucket labeled B1 has 20 values that fall between 100 and 199 on the attribute over which the histogram is constructed. Fifteen of those values are distinct so that on average a value occurs slightly more than three times.

Error-Metrics

One can distinguish between two types of errors that occur when constructing a histogram. A first type of error arises when the histogram is constructed through sampling. This error measures to what degree a histogram constructed over a sample approximates a histogram constructed by a full scan of the data (i.e., a perfect histogram). A second type of error measures how accurately a histogram (even a perfect histogram) captures the underlying data distribution. Histogram constructions differ primarily in how the bucket separators are slected to reduce this second type of error. For example, equi-depth bucketing forms buckets of equal sizes. Table 1 is an example of an equi-depth histogram.

Various metrics have been proposed for the first type of error. Consider a table with n tuples, containing an attribute X over a totally ordered domain D. An approximate k-bucket histogram over the table is constructed through sampling as follows. Suppose a sample of r tuples is drawn from the relation or table. A bucketing algorithm uses the sample to decide a sequence of separators s₁, s₂, . . . , sₖ₋₁ ε D. These separators partition D into k buckets B₁, B₂, . . . , Bₖ where Bᵢ={vεD|sᵢ₋₁<v≦sᵢ} (take s₀=−∞ and sₖ=∞). Let ñᵢ be the size (i.e., number of tuples) of Bᵢ in the sample, and nᵢ be the size of Bᵢ in the table. The histogram estimates nᵢ as

$${\hat{n}}_{i} = \frac{n}{r} \cdot {\tilde{n}}_{i} .$$

The histogram is perfect if nᵢ=\hat{n}ᵢ for i=1, 2, . . . , k.

A variance-error metric measures the mean squared error across all buckets, normalized with respect to the mean bucket size:

$${Δ}_{var} = \frac{k}{n} \sqrt{\frac{1}{k} {\sum }_{i = 1}^{k} {( {\hat{n}}_{i} - {n}_{i} )}^{2}} \qquad ( 1 )$$

For the special case of equi-depth histograms, the problem of deriving the uniform-random sample size required to reach a given variance-error with high probability has been considered.

The max-error metric measures the maximum error across all buckets:

$${Δ}_{max} = {max}_{i} \{ \frac{\vert {{n}^{⋒}}_{i} - {n}_{i} \vert}{( n / k )} \} \qquad ( 2 )$$

For equi-depth histograms, the uniform-random sample size needed to reach a desired max-error with high probability has also been derived.

It has been observed that the max-error metric is overly conservative (and unstable): a single bad bucket unduly penalizes a histogram whose accuracy is otherwise tolerable in practice. Conversely, an unreasonably large sample size is often required to achieve a desired error bound. This was especially true when the layout was “bad” for block-level sampling.

The layout of a database table (i.e., the way the tuples are grouped into blocks) can significantly affect the error in a histogram constructed over a block-level sample. This point was recognized in Chadhuri et al, and is illustrated by the following two extreme cases:
Random Layout: For a table in which the tuples are grouped randomly into blocks, a block-level sample is equivalent to a uniform-random sample. In this case, a histogram built over a block-level sample will have the same error as a histogram built over a uniform-random sample of the same size.
Clustered Layout: For a table in which all tuples in a block have the same value in the relevant attribute, sampling a full block is equivalent to sampling a single tuple from the table (since the contents of the full block can be determined given one tuple of the block). In this case, a histogram built over a block-level sample will have a higher error as compared to one built over a uniform-random sample of the same size.

In practice, most real table layouts fall somewhere in between these two extremes. For example, suppose a relation was clustered on the relevant attribute, but at some point in time the clustered index was dropped. Now suppose inserts to the relation continue to happen. This results in the table becoming “partially clustered” on this attribute. As another example, consider a table which has columns Age and Salary, and is clustered on the Age attribute. Further, suppose that a higher age usually (but not always) implies a higher salary. Due to clustering on Age, the table will also be “almost clustered” on Salary.

The system constructs a histogram with a desired error bound. The above examples show that the block-level sample size required to reach the desired error depends significantly on the layout of the table. The exemplary system addresses the problem of constructing a histogram with the desired error bound through block-level sampling by adaptively determining the required block-level sample size according to the layout.

Prior Art Cross-Validation Based Iterative Approach

The idea behind cross-validation is the following. First, a block-level sample S₁ of size r is obtained, and a histogram H having k buckets is constructed on it. Then another block-level sample S₂ of the same size is drawn. Let ñᵢ be the size of the i^{th} bucket of H in S₁, and \tilde{m}ᵢ be its size in S₂. Then, the cross-validation error according to the variance error-metric is given by:

$${Δ}_{var}^{CV} = \frac{k}{r} \sqrt{\frac{1}{k} {\sum }_{i = 1}^{k} {( {\tilde{n}}_{i} - {\tilde{m}}_{i} )}^{2}} \qquad ( 3 )$$

It is unlikely that the cross-validation error is low when the actual error is high. Based on this fact, a prior art process was proposed by Chaudhuri et al to arrive at the required block-level sample size for a desired error. Let r_{unf} (resp. r_{blk}) be the uniform-random sample size (resp. block-level sample size) required to reach the desired error. The algorithm starts with an initial block-level sample of size r_{unf}. The sample size is repeatedly doubled and cross-validation performed, until the cross-validation error reaches the desired error target. A limitation of the Chaudhuri et al process is that it always increases the sample size by a factor of two. This procedure hurts in both the following cases:
Each iteration of the algorithm incurs considerable fixed overheads of drawing a random block-level sample, sorting the incremental sample, constructing a histogram, and performing the cross-validation test. For significantly clustered data where r_{blk} is much larger than r_{runf}, the number of iterations becomes a critical factor in the performance.
If at some stage in the iterative process, the sample size is close to r_{blk}, the algorithm is oblivious of this, and samples more than required. In fact in the worst case, the total sample drawn maybe four times r_{blk}, because an additional sample of the same size is required for the final cross-validation.

To remedy these limitations, a challenge of the exemplary embodiment is to develop an approach which (a) goes through a much smaller number of iterations (ideally one or two) so that the effect of the overhead per iteration is minimized, and (b) does not significantly overshoot the required sample size.

Theory of the Exemplary Process

As mentioned, bucketing algorithms typically use heuristics for determining bucket separators in order to minimize the error in approximating the true distribution. The theory underlying the exemplary system adopts a simplified model of histogram construction to keep it analyzable and away from details of specific bucketing algorithms. This model assumes that the bucketing process produces histograms over any two different samples have the same bucket separators, and differ only in the estimated counts of the corresponding buckets. In a general case, two different samples may produce histograms that differ in separator positions as well as counts of corresponding buckets. However, the simplification is merely for analytical convenience, and the exemplary embodiment can work with any histogram construction process and does not actually attempt to fix bucket boundaries.

Error vs Sample Size

Consider a table with n tuples. Let there be N blocks in the table with b tuples per block (N=n/b). (note, a common block size of 8K bytes might have approximately 100 records or tuples in the database table) Given a k-bucket histogram H, consider the distribution of the tuples of bucket Bᵢ among the blocks. Let a fraction aᵢⱼ of the tuples in the j^{th} block belong to bucket

$${B}_{i} ( {n}_{i} = b \cdot {\sum }_{j = 1}^{N} {a}_{ij} ) .$$

Let σᵢ² denote the variance of the numbers aᵢⱼ (j=1, 2, . . . , N). Intuitively, σᵢ² measures how evenly bucket Bᵢ is distributed among the blocks. If it is fairly evenly distributed, σᵢ² will be small. On the other hand, if the bucket Bᵢ is concentrated in relatively few blocks, σᵢ² will be high.
Theorem 1 Suppose a histogram H constructed over a block-level sample of r tuples is cross-validated against another block-level sample of r tuples. For the same bucket separators,

$$E [ {( {Δ}_{var}^{CV} )}^{2} ] = \frac{2 kb}{r} {\sum }_{i} {σ}_{i}^{2}$$

The Following Two Conclusions can be Made:
1. The expected squared cross-validation error is inversely proportional to the sample size. This forms the basis of a more intelligent step factor than the factor of two in the iterative approach of Chaudhuri et al.
2. The quantity

$${\sum }_{i = 1}^{k} {σ}_{i}^{2}$$
represents a crisp quantitative measure of the “badness” of a layout for constructing histograms. If this quantity is large, the cross-validation error (and also the actual variance-error) is large, and a larger block-level sample for the same accuracy is needed. This measure also depends on the choice of bucket separators. Refer to this quantity as Hist_Badness.
   Exemplary Two Phase Histogram Construction Process

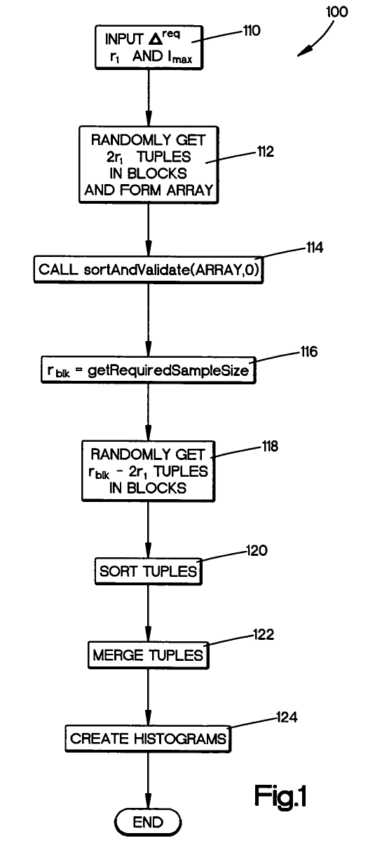

The flowchart of FIG. 1 describes a process 100 that utilizes this result to build a histogram with a desired error threshold. For simplicity, the process assumes that the threshold is specified in terms of the desired cross-validation error Δ^{req} (since the actual error is typically less). Theorem 1 gives an expression for the expected squared cross-validation error, i.e., it is proportional to Hist_Badness and inversely proportional to the block-level sample size. Since in general Hist_Badness is not known (such information about the layout is almost never directly available), the exemplary embodiment adopts the following 2-phase approach: draw an initial block-level sample in the first phase and use it to try and estimate Hist_Badness (and consequently the required block-level sample size), then draw the remaining block-level sample and construct the final histogram in the second phase.

The performance of this overall approach depends on how accurate the first phase is in determining the required sample size. An accurate first phase makes this approach better than the cross-validation approach of Chaudhuri et al because (a) there are far fewer iterations and therefore fewer overheads, (b) the chance of overshooting the required sample size is reduced, and (c) there is no final cross-validation step to check whether the desired accuracy has been reached.

One implementation of the first phase is as follows. Pick an initial block-level sample of size 2r_{unf} (where r_{unf} is the theoretical sample size that achieves an error of Δ^{req} assuming uniform-random sampling). Divide this initial sample into two halves, build a histogram on one half and cross-validate this histogram using the other half. Suppose the observed cross-validation error (from equation 3) is Δ^{obs}. If Δ^{obs}≦Δ^{req} the process is complete, otherwise the required block-level sample size r_{blk} can be derived from Theorem 1 to be

$${( \frac{{Δ}^{obs}}{{Δ}^{req}} )}^{2} \cdot {r}_{unf} \cdot É1$$

An alternate embodiment, however, is deemed to be more robust. Since Theorem 1 holds only for expected squared cross-validation error, using a single estimate of the cross-validation error to predict r_{blk} may be very unreliable. In accordance with this alternate embodiment, the prediction of r_{blk} is based on data from a number of trials. In a first phase of this alternative embodiment, the first phase performs multiple cross-validation trials for estimating r_{blk} accurately. However, this robustness comes with almost no performance penalty. The multiple cross validations are piggybacked on sorting, so that the resulting time complexity is comparable to that of a single sorting. Since most histogram construction algorithms require sorting anyway, this sharing of cross-validation and sorting leads to a robust yet efficient histogram construction.

In reviewing the flowchart of FIG. 1, the merge 122, sort 120, createHistogram 124 are methods that are callable from the routine 100. The first two have their standard functionality. The function createHistogram can be any prior art histogram construction algorithm such as the equi-depth algorithm, or the maxdiff algorithm. A function getSquaredError called by a sortAndValidate procedure 114 cross-validates a given histogram against a given sample, and returns the squared cross-validation error (Δᵥₐᵣ^{CV})², according to Equation 3.

The process of FIG. 1 begins with receipt 110 of three inputs, one or which is the degree of accuracy desired in the final or resultant histogram that is constructed. Based on an input r₁, the process described in the FIG. 1 flowchart randomly gathers 112 an initial block-level sample of size 2r₁. This parameter can be set as r_{unf}, however, in practice it is found that a setting that is two to three times larger yields much more robust results.

Coss-validation is performed on different size subparts of the initial sample, where the task of cross-validation is combined with that of sorting. This piggybacking is implemented by calling the sortAndValidate procedure 114. Pseudocode for a suitable recursive sortAndValidate procedure is listed below in listing 1.

Listing 1

SortAndValidate(A[1...m], l)
1. if(l = lmax)
2. sort(A[1...r)
3. else
4. m = [r/2]
5. sortAndValidate(A[1...m],l+1)
6. sortAndValidate(A[m+1...r],l+1)
7. lh = createHistogram(A[m+1...r],l+1)
8. rh = createHistogram(A[m+1...r])
9. sqErr[l] += getSquaredError(lh, A[m+1...r])
10. sqErr[l] += getSquaredError(rh, A[1...m])
11. merge(A[1...m], A[m+1...r])

The sortAndValidate process has two inputs, an array (designated Array) and an integer value (designated 1). This integer value indicates how many times the array is broken in half during cross correlation.

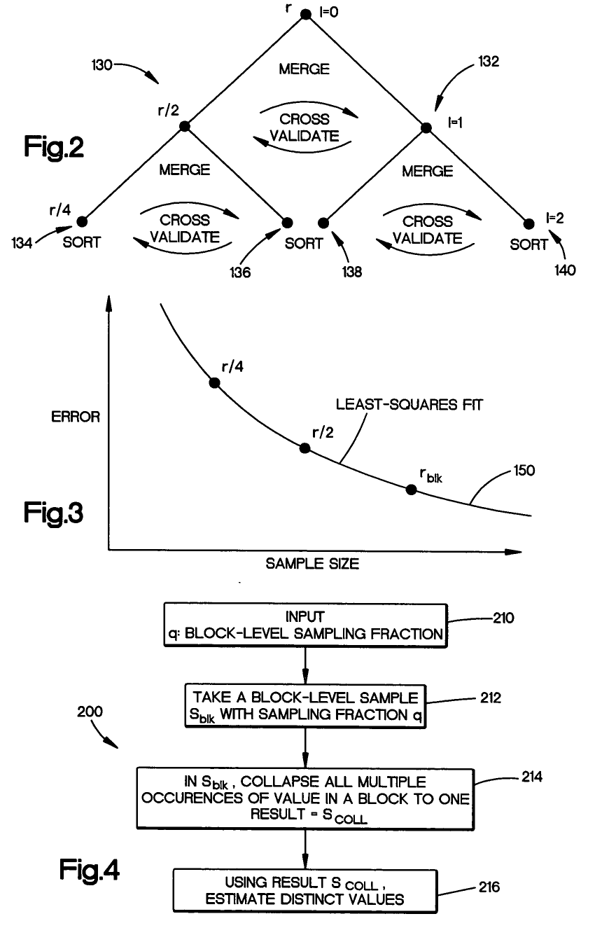

The sortAndValidate process uses an in-memory merge-sort for sorting the sample (for the sample sizes at which the process operates, it is assumed the sample easily fits in memory). Consider the FIG. 2 depiction of a process of sorting and cross-validating a sample of size r with 1=2. The sample is divided into two half size samples 130,132 (FIG. 2). Each of these two samples is further divided into the four sub-samples 134, 136, 138, 140 which are recursively sorted and cross-validated in pairs. Then, histograms are built on the left and right samples 130,132. Each histogram is tested against the other half, and two estimates of (Δᵥₐᵣ^{CV})² for a sample of size r/2 are obtained. Note that the recursive cross-validation of the two halves will give several (Δᵥₐᵣ^{CV})² estimates for each sample size r/4,r/8. . . etc. The process reuses subparts of the sample to get several different cross-validation error estimates on different size samples.

Although a quick-sort is typically the fastest in-memory sort (and is the method of choice in traditional in-memory histogram construction algorithms), merge-sort is not much slower. Moreover, it allows combining the cross-validation with the sorting. The merge-sort is parameterized to not form its entire recursion tree, but truncate it after the number of levels has increased to a threshold (lₘₐₓ) This reduces the overall overhead of cross-validation. Also, at lower sample sizes, error estimates lose statistical significance. Usually a small number such as lₘₐₓ=3 suffices for our purposes. At the leaves of the recursion tree, a quick-sort is performed rather than continuing with merge-sort.

Once this sorting phase of FIG. 2 is complete, the process has produced several (Δᵥₐᵣ^{CV})² estimates corresponding to each sample size r₁/2 , . . . , r₁/2^{lmax-1}. For each sample size the process computes a mean of these estimates.

The process then finds a best fit for a curve 150 (See FIG. 3) of the form Δ²=c/r justified by Theorem 1) to fit the observed points. In this curve, c is a constant, and Δ² is the average squared cross-validation error observed for a sample of size r. This curve fitting is done using the standard method of least-squares. The best-fit curve yields a value of c which is used to predict r_{blk} by putting Δ=Δ^{req}. This is done in the procedure getRequiredSampleSize whose pseudo-code is contained in listing 2.

Listing 2

| | |
|---|---|
| 1. | if (sqErr[0]/2 <= ((Δ^{req})²) |
| 2. | return 2r₁ |
| 3. | else |
| 4. | Fir a curve of the form y = c/x through the points r₁/2ⁱ, |
| | sqErr[i]/2ⁱ⁺¹) for i = 0, 1, . . ., 1ₘₐₓ − 1 |
| 5. | $return \frac{c}{{( {Δ}^{req} )}^{2}}$ |

Once an estimate for r_{blk} is obtained, the process enters Phase II. The additional sample required (of size r_{blk} −2r₁) is obtained and sorted 120. It is merged 122 with the (already sorted) first-stage data sample and a histogram is built 124 on the total sample, and returned.

Note the exemplary embodiment seeks to reach the cross-validation error target in the expected sense, thus there is a theoretical possibility that the error target may not be reached after the second phase. One way to avoid this problem would be to develop a high probability bound on the cross-validation error (rather than just an expected error bound as in Theorem 1), and modify the process so that it reaches the error target with high probability. Another alternative would be to extend the process to a multi-phase approach, where the step size is decided as described above, but a termination criterion is based on a final cross-validation step. Experience with the exemplary system, however, indicates that the actual variance-error (which is typically substantially smaller than the cross-validation error) is below the error target.

Distinct Value Estimator

An exemplary system also estimates the number of distinct values on an entire Database column or attribute X through block-level sampling. Most histograms, in addition to “quantity” information for each bucket, also keep “distinct values” information for each bucket. If the exemplary technique can compute distinct-values for an entire column or attribute using block-samples, it can also be used for computing distinct-values for each bucket using block-samples.

The problem of deciding how much to sample to reach a desired accuracy of distinct value estimation is an open question. This seems to crucially depend on analytical error guarantees, which are unavailable for most distinct-value estimators even with uniform-random sampling.

Let D be the number of distinct values in the column, and let \hat{D} be the estimate returned by an estimator. The bias and error of the distinct value estimators are defined as:
Bias=|E[\hat{D}]−D|
Error=max{\hat{D}/D,D/\hat{D}}

The definition of error is provided according to the ratio-error metric defined in Charikar et al “Towards estimation error guarantees for distinct values.” In Proc. Of the ACM Symp. On Principles of Database Systems, 2000. A perfect estimator has error =1. Notice that it is possible for an estimator to be unbiased (i.e. E[\hat{D}]=D), but still have high expected error.

The exemplary system leverages existing estimators which have been designed for uniform-random samples and makes them work for block-level samples. Moreover, it uses these estimators with block-level samples in such a way, that the bias and error are not much larger than when these estimators are used with uniform-random samples of the same size.

Consider a random sample of data (Table 1 below) over a database having an attribute that has an integer value of between 0 and 100. This attribute could correspond to age, income in thousands of dollars, percentile rank on tests or any of a number of other characteristics. Consider the value for a series of tuples and also consider the tuples that are chosen at random to give a 20 percent (one in five) sampling.

TABLE 1

| | Rec no | | | | | | | | | | | | | | |
|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 |
| value | 25 | 30 | 30 | 30 | 15 | 20 | 50 | 50 | 60 | 100 | 90 | 80 | 70 | 60 | 60 |
| | | | X | | | | X | | | | | X | | | |
| | Rec no | | | | | | | | | | | | | | |
| | 16 | 17 | 18 | 19 | 20 | 21 | 22 | 23 | 24 | 25 | 26 | 27 | 28 | 29 | 30 |
| value | 10 | 15 | 30 | 50 | 40 | 35 | 55 | 65 | 15 | 50 | 65 | 75 | 90 | 90 | 40 |
| | | | X | | | | | X | | | X | | | | |

Records 3, 7, 12, 18, 23, and 26 from the table are randomly chosen. These records can be broken into two sets, Set1 are those randomly selected tuples that have values that are duplicated (frequent) and Set2 are those randomly selected tuples (rare) that do not repeat. Set1={30, 65} and Set2={50, 80}. Existing estimators that distinguish between rare and frequent tuples have been experimentally evaluated, and found to perform well on uniform-random samples which are divided into the aforementioned sets.

One existing estimator is the GEE estimator, which estimates the number of distinct values as (size of Set1)*sqr(n/r)+(size of Set 2). Here, n is the number of tuples in the entire table, and r is the number of tuples in the sample.

These prior art estimators include the HYBSKEW estimator (See P. Haas et al. “Sampling-based estimation of the number of distinct values of an attribute” In Proc. Of the 1995 Intl. Conf on Very Large Data Bases, pages 311-322, September 1995. incorporated herein by reference), the smoothed jackknife estimator, the Shlosser estimator, the GEE estimator, and the AE estimator.

First consider the following estimation approach (called TAKEALL) for distinct-value estimation with block-level sampling:

TAKEALL: Take a block-level sample S_{blk} with sampling fraction q. Use S_{blk} with an existing estimator as if it were a uniform-random sample with sampling fraction q.

Using existing estimators may return very poor estimates if used with TAKEALL. Let d be the number of distinct values in the sample. Let there be fᵢ distinct values which occur exactly i times in the sample. All the estimators mentioned above have the common form \hat{D}=d+K·f₁, where K is a constant chosen adaptively according to the sample (or fixed according to the sampling fraction as in GEE). The rationale behind this form of the estimators is as follows. Intuitively, f₁, represents the values which are “rare” in the entire table (have low multiplicity), while the higher frequency elements in the sample represent the values which are “abundant” in the table (have high multiplicity). A uniform-random sample is expected to have missed only the rare values, and none of the abundant values. Hence the estimators need to scale-up only the rare values to get an estimate of the total number of distinct values.

Consider a database table in which the multiplicity of every distinct value is at least 2. Further, consider a layout of this table such that for each distinct value, its multiplicity in any block is either 0 or at least 2. For this layout, in any block-level sample (of any size), f₁=0. Thus, in this case, all the above estimators will return \hat{D}=d. Effectively, no scaling is applied, and hence the resulting estimate may be highly inaccurate.

More generally, the reason why these estimators fail when used with TAKEALL, is as follows. When a particular occurrence of a value is picked up in a block-level sample, any more occurrences of the same value in that block are also picked up—but by virtue of being present in that block, and not because that value is a frequent one. Thus, multiplicity across blocks is a good indicator of abundance, but multiplicity within a block is a misleading indicator of abundance.

Collapse

The exemplary system considers a value to be abundant only if it occurs in multiple blocks in the sample, while multiple occurrences within a block are considered as only a single occurrence. This is referred to as collapsing of multiplicities within a block.

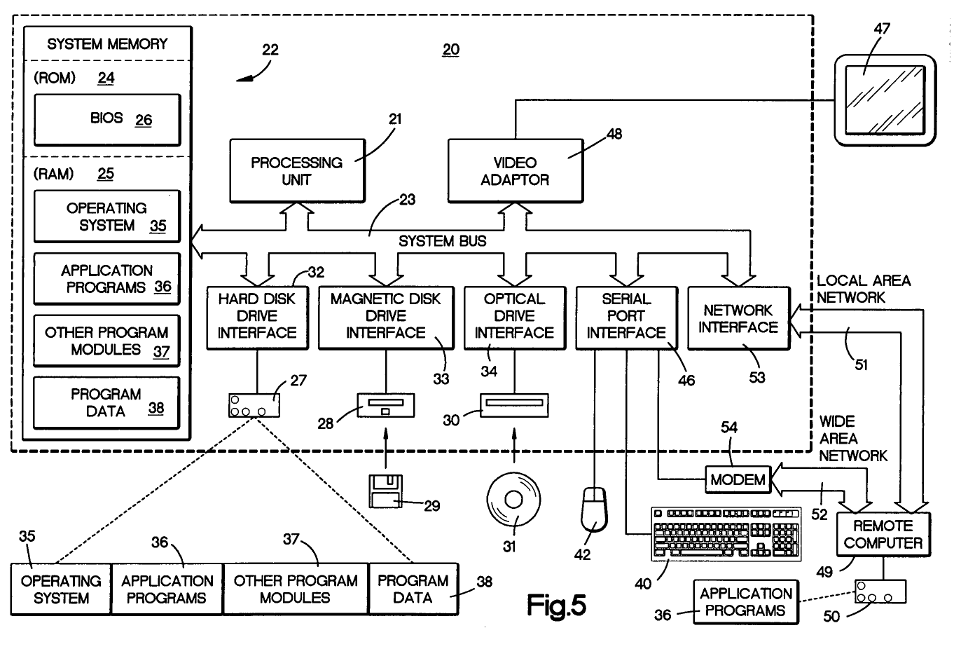

The process COLLAPSE is shown in FIG. 4. The process receives 210 as an input q, a fraction of the total database and proceeds to randomly obtain 212 blocks until the specified fraction of the database have been obtained. If one knows the block size and the size of block samples, one can easily determine how many blocks must be gathered.

Multiplicities within blocks of a block-level sample are first collapsed 214, and then existing estimators are directly run 216 on the collapsed sample, i.e., the collapsed sample is simply treated as if it were a uniform-random sample with the same sampling fraction as the block-level sample.

The COLLAPSE process is as accurate as true random sampling of the database and is much more efficient. Let T be the table on which one seeks an estimate of the number of distinct values. Let vᵢ denote the i^{th} distinct value. Let nᵢ be the tuple-level multiplicity of vᵢ, i.e., the number of times it occurs in T, and Nᵢ be the block-level multiplicity of vᵢ, i.e., the number of blocks of T in which it occurs. Let S_{blk} be a block-level sample from T with sampling fraction q, and S_{coll} be the sample obtained after applying the collapse step to S_{blk}. Let T_{coll} be an imaginary table obtained from T by collapsing multiple occurrences of values within every block into a single occurrence. Let S_{unf} be a uniform-random sample from T_{coll} with the same sampling fraction q. Notice that T_{coll} may have variable-sized blocks, but this does not affect our analysis. As before, let fᵢ denote the number of distinct values which occur exactly i times in a sample. It can be shown that Lemma 1 below is true.

Lemma 1 For the Bernoulli sampling model, E[fᵢinS_{coll}]=E[fᵢinS_{unf}] for all i.

Now consider any distinct-value estimator E of the form

$$\hat{D} = {\sum }_{i = 1}^{r} {a}_{i} {f}_{i}$$

(where aᵢ's are constants depending on the sampling fraction). It can show that for use with estimator E, S_{coll} is as good as S_{unf}(in terms of bias). Let B(T_{coll},q) be the bias of E when applied to uniform-random samples from T_{coll} with sampling fraction q. Let B_{coll} (T,q) be the bias of E when applied to block-level samples from T with sampling fraction q, and which have been processed according to the collapse step.
The following theorm is found to be true.
Theorem
B(T_{coll},q)=B_{coll}(T,q)

Thus, the theorem reduces the problem of distinct value estimation using block-level samples to that of distinct value estimation using uniform random samples of a modified (i.e. collapsed) table.

Computer System

An exemplary system is implemented as a client application executing on a client computer 224 that accesses a database reference table in a database 222 maintained on a server computer 220 running a database management system such as SQLServer® or the like. While the client application could be executing on the server computer, an alternative possibility is that the client application is executing on a separate client computer.

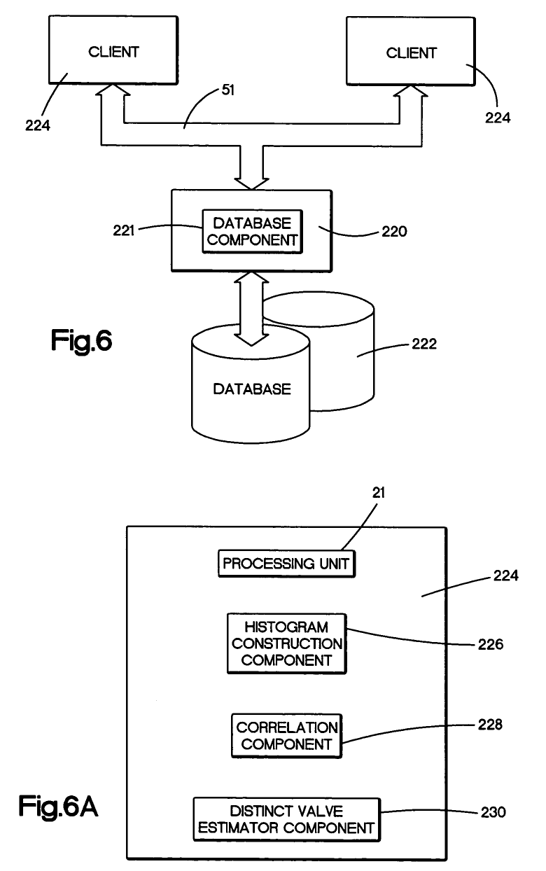

Such a system is depicted in FIGS. 6 and 6A. The database system of those figures constructs histograms based on sampling the contents of the database 222. A database management component 221 that gathers block size data segments from the database 222 which in aggregate form a first sample of data having a first size. This data is transferred by the network 51 to a client 224. At the client a histogram construction component 226 forms two or more histograms from the first sample of data. A correlation component 228 determines an initial sufficiency of the first sample of data gathered from the database 222 based on a comparison of the two or more histograms. If needed the database management component 221 of the server computer 220 gathers an additional sample of data used by said histogram construction component in creating a resultant histogram and the size of the additional sample is based on the initial sufficiency determination. In one embodiment, the client computer 224 includes a distinct value estimator component 230 which makes use of the block size sampled data from the database in determining distinct value estimates of the contents of the histograms constructed by the component 226.

FIG. 5 depicts an exemplary data processing system which can implement both the database management server computer and the client. The FIG. 5 data processing system includes a general purpose computing device in the form of a conventional computer 20, including one or more processing units 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures.

The system memory includes read only memory (ROM) 24 and random access memory (RAM) 25. A basic input/output system 26 (BIOS), containing the basic routines that helps to transfer information between elements within the computer 20, such as during start-up, is stored in ROM 24.

The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide nonvolatile storage of computer readable instructions, data structures, program modules and other data for the computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROM), and the like, may also be used in the exemplary operating environment.

A number of program modules may be stored on the hard disk, magnetic disk 29, optical disk 31, ROM 24 or RAM 25, including an operating system 35, one or more application programs 36, other program modules 37, and program data 38. A user may enter commands and information into the computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB). A monitor 47 or other type of display device is also connected to the system bus 23 via an interface, such as a video adapter 48. In addition to the monitor, personal computers typically include other peripheral output devices (not shown), such as speakers and printers.

The computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, intranets and the Internet.

When used in a LAN networking environment, the computer 20 is connected to the local network 51 through a network interface or adapter 53. When used in a WAN networking environment, the computer 20 typically includes a modem 54 or other interface hardware for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing a communications link between the computers may be used.

Although exemplary embodiments of the invention have been described with a degree of particularity, it is the intent that the invention include all modifications and alterations falling within the spirit or scope of the appended claims.

1. In a database system, a sampling method for constructing a data structure based on the contents of a database comprising:
a) gathering an initial sample of data from the database and creating a first data structure from said initial sample;
b) gathering a second sample of data from the database;
c) determining an initial sufficiency of the data gathered from the database that is based on a comparison of the first data structure and the second sample of data; and
d) forming a resultant data structure by gathering an additional sample of data from the database and using the additional amount of data to form the resultant data structure wherein the amount of data gathered in the additional sample is based on the initial sufficiency determination.

2. The method of claim 1 wherein the resultant data structure is formed based on data gathered in the initial sample, the second sample and the additional sample.

3. The method of claim 1 wherein the first and resultant data structures are histograms.

4. The method of claim 1 wherein the initial and second data samples are randomly retrieved block samples that form a first amount of data that is initially gathered and then divided in half to provide the initial and second data samples.

5. The method of claim 4 wherein the initial and second data samples are sorted and used to form two histograms.

6. The method of claim 5 wherein an error metric of the two histograms are formed by cross correlating the contents of the two histograms to determine the initial sufficiency.

7. The method of claim 6 wherein the initial and second data samples are further sub-divided to form sub-samples used to form other histograms of differing sample sizes that are cross correlated to find an error metric relating to said differing sample sizes.

8. The method of claim 6 wherein the initial and second data samples are further sub-divided to form additional sub-samples of smaller size that are used to form other histograms that are cross correlated for use in finding an error metric relating to sample sizes for use in determining a size of the additional sample of data to gather from the database.

9. The method of claim 4 additionally comprising estimating distinct values of an attribute of the initial and second samples by eliminating records from the blocks that are duplicated within a given block and estimating distinct values by categorizing attributes as rarely or frequently occurring within the database.

10. A computer readable medium for performing computer instructions to implement the method of claim 1.

11. A database system for constructing histograms based on sampling the contents of the database comprising:
a) a database management component that gathers block size data segments from the database which in aggregate form a first sample of data having a first size;
b) a histogram construction component that forms a first histogram from the first sample of data; and
c) a correlation component that determines an initial sufficiency of the first sample of data gathered from the database based on a comparison of the first histogram and data from the first sample of data;
d) wherein said database management component gathers an additional sample of data used by said histogram construction component in creating a resultant histogram and the size of the additional sample is based on the initial sufficiency determination.

12. The system of claim 11 wherein the resultant histogram is formed by the histogram construction component based on data gathered in the first sample of data and the additional data.

13. The system of claim 11 wherein the first sample of data and the additional sample of data are randomly retrieved block samples.

14. The system of claim 11 wherein histogram construction component sorts the data in said first sample of data as it constructs the first histogram.

15. The system of claim 11 wherein the correlation component determines an error metric by cross correlating the contents of the first histogram with other data in said first sample of data to determine the initial sufficiency.

16. The system of claim 15 wherein the first sample of data is sub-divided to form sub-samples used to form histograms of differing sizes that are cross correlated to find an error metric relating to said differing sample sizes.

17. The system of claim 15 wherein the first sample of data is sub-divided to form additional sub-samples of smaller size that are used to form other histograms that are cross correlated for use in finding an error metric relating to sample sizes for use in determining a size of the additional sample of data to gather from the database.

18. In a database system, a sampling method for constructing a histogram based on the contents of a database comprising:
a) gathering an initial sample of data from the database and creating a histogram from said initial sample;
b) gathering a second sample of data from the database for comparison with said first histogram;
c) determining an initial sufficiency of the data gathered from the database that is based on a comparison of the second sample with the first histogram; and
d) if the determination of initial sufficiency indicates the data in said initial and second samples is adequate to represent the database, combining the initial and second samples to form a resultant histogram, but if the determination of initial sufficiency indicates the initial and second samples are inadequate to represent the database, gathering an additional data sample to combine with the initial and second samples to form the resultant histogram wherein a size of the additional data sample is based on the initial sufficiency determination.

19. The method of claim 18 wherein the data is gathered in blocks from random storage locations within the database.

20. In a database system, a system for constructing a data structure based on the contents of a database comprising:
a) means for gathering an initial sample of data from the database and creating a first data structure from said initial sample;
b) means for determining an initial sufficiency of the data gathered from the database that is based on a comparison of the first data structure and other data in the initial sample not used to create the first data structure; and
c) means for forming a resultant data structure by gathering an additional sample of data from the database and using the additional amount of data to form the resultant data structure wherein the amount of data gathered in the additional sample is based on the initial sufficiency determination.

21. The system of claim 20 wherein the resultant data structure is formed based on data gathered in the initial sample and the additional sample.

22. The system of claim 21 wherein the first and resultant data structures are histograms.

23. The system of claim 20 wherein the initial data sample is made up of randomly retrieved block samples that form a first amount of data that is divided in half to provide data to form the data structure and data to cross correlate against the first data structure.

24. The system of claim 23 wherein the initial data samples is sorted and used to form two histograms.

25. The system of claim 24 wherein an error metric of the two histograms are formed by cross correlating the contents of the two histograms to determine the initial sufficiency.

26. The system of claim 25 wherein the initial data sample is further sub-divided to form sub-samples used to form other histograms of differing sample sizes that are cross correlated to find an error metric relating to said differing sample sizes.

27. The system of claim 26 wherein the initial and second data samples are further sub-divided to form additional sub-samples of smaller size that are used to form other histograms that are cross correlated for use in finding an error metric relating to sample sizes for use in determining a size of the additional sample of data to gather from the database.

28. The system of claim 24 additionally comprising means for estimating distinct values of an attribute of the initial and second samples by eliminating records from the blocks that are duplicated within a given block and estimating distinct values by categorizing attributes as rarely or frequently occurring within the database.

29. In a database system, a method for estimating distinct values of database attributes comprising:
a) gathering a plurality of block sized samples from the database;
b) organizing records gathered from the database into a first set of records where an attribute of a record is duplicated in different blocks and a second set of records wherein the attribute of a record is not duplicated in different blocks; and
c) estimating the number of distinct values of records in the database based on records in said first and second sets.

30. The method of claim 29 where records in a block are scanned to find attributes with duplicate values and where all records found to have a duplicate value for the attribute are collapsed into a representative record within the block.

31. The method of claim 29 wherein the samples are gathered from random locations in the database.

32. A computer readable medium for performing computer instructions to implement the method of claim 20.

33. A database system for determining database statistics comprising:
a) a database management component for gathering block size data segments from the database; and
b) an estimating component that organizing records gathered from the database into a first set of records where an attribute of a record is duplicated in different blocks and a second set of records wherein the attribute of a record is not duplicated in different blocks; and estimates the number of distinct values of records in the database based on records in said first and second sets.

34. In a database system, a method for estimating distinct values of database attributes comprising:
a) randomly gathering a plurality of block sized samples from the database;
b) modifying the contents of the samples by evaluating records in a block to find records having the same value for an attribute and collapsing all records found to have the same value for the attribute into a representative record within the block to provide modified block samples; and
c) estimating the number of distinct values of records in the database based on records in said modified block samples.
